(19) United States
(12) Patent Application Publication
(10) Pub. No.: US 2017/0214966 A1
(43) Pub. Date: Jul. 27, 2017

(54) AUDIO AND VIDEO PLAYING SYSTEM AND METHOD

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Yonggui Zhao, Tianjin (CN)

(21) Appl. No.: 15/245,679

(22) Filed: Aug. 24, 2016

Related U.S. Application Data
(63) Continuation of application No. PCT/CN2016/088856, filed on Jul. 6, 2016.

(30) Foreign Application Priority Data
Jan. 26, 2016 (CN) 201610054876.3

(51) Int. Cl. H04N 21/439; H04N 21/4363; H04R 1/10; H04N 21/41

(52) U.S. Cl. CPC H04N 21/4396; H04N 21/4126; H04N 21/43637; H04R 1/1041; H04R 2420/07

(57) ABSTRACT

Disclosed are an audio and video playing system and method. This system includes: an audio and video playing device, a mobile terminal and an earphone; wherein the audio and video playing device is connected to the mobile terminal in a wireless manner, the earphone is connected to the mobile terminal in a wireless or wired manner, and audio and video signals are played by using the audio and video playing device, the audio signal being transmitted to a corresponding mobile terminal for playing, a user receiving the audio signal via the earphone. The present disclosure is simple in operation. During watching large frames by the audio and video playing device such as televisions and the like, sound may be simultaneously received by using the mobile terminal such as mobile phones and the like. Therefore, watching demands of users are accommodated and user experience of users is improved, without affecting others.

### CROSS REFERENCE TO RELATED APPLICATIONS

This application is a continuation of International Application No. PCT/CN2016/088856 with an international failing date of Jul. 6, 2016, which is based upon and claims priority to Chinese Patent Application No. CN201610054876.3, filed on Jan. 26, 2016, the entire contents of all of which are incorporated herein by reference.

### TECHNICAL FIELD

The present disclosure relates to the technical field of audio and video playing, and more particularly, to an audio and video playing system and method.

### BACKGROUND

A favorite program is being played on the television. However, the old or children are taking a rest. On the premise of not affecting the old or children's rest, in order to not miss the program, a user have to mute the television or turn down the volume or watch the program over a mobile phone. However, appreciation of the program is degraded and user experience is badly affected because the playing screen of the mobile phone is too small.

### SUMMARY

The present disclosure provides an audio and video playing system and method, to solve the technical problem that appreciation of programs is degraded and user experience is affected due to failure to play audio signals during playing the programs over a television.

In order to solve the above problem, embodiments of the present disclosure employ the following technical solutions:

an audio and video playing system is disclosed, including: an audio and video playing device, a mobile terminal and an earphone; wherein the audio and video playing device is connected to the mobile terminal in a wireless manner, the earphone is connected to the mobile terminal, and audio and video signals are played by using the audio and video playing device, the audio signal being transmitted to a corresponding mobile terminal for playing, a user receiving the audio signal via the earphone.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram illustrating an audio and video playing system according to some embodiments of the present disclosure; and

FIG. 2 is a schematic flowchart illustrating an audio and video playing method according to some embodiments of the present disclosure.

### DETAILED DESCRIPTION

For better understanding of the present disclosure, the present disclosure is thoroughly described with reference to relevant accompanying drawings. The accompanying drawings show preferred embodiments of the present disclosure. However, the present disclosure may be implemented in a plurality of forms or ways, and is not limited to the embodiments described herein. On the contrary, the embodiments described herein are intended to make the disclosure of the present disclosure more clearly and thoroughly understood.

Unless otherwise defined, all the technical and scientific terms used in this specification convey the same meanings as the meanings commonly understood by a person skilled in the art to which the present disclosure pertains. Additionally, the terms used in the specification the present disclosure are merely for describing the objective of the specific embodiments, and are not intended to limit the present disclosure.

An audio and video playing system according to a first embodiment of the present disclosure includes: an audio and video playing device, a mobile terminal and an earphone; wherein the audio and video playing device is connected to the mobile terminal in a wireless manner, the earphone is wirelessly or connected to the mobile terminal in a wireless manner, and audio and video signals are played by using the audio and video playing device, the audio signal being transmitted to a corresponding mobile terminal for playing, a user receiving the audio signal via the earphone.

According to the first embodiment of the present disclosure, in the audio and video playing system, the audio and video playing device is connected to the mobile terminal, and when the audio signals may not played by using the audio and video playing device, the audio signal is transmitted to the mobile terminal, and the user receives the audio signal by using the earphone connected to the mobile terminal.

The audio and video playing system according to the first embodiment of the present disclosure is simple in operation. During watching of large frames by the audio and video playing device such as a television and the like, sound may be simultaneously received by using the mobile terminal such as a mobile phone and the like. Therefore, watching demands of the user are accommodated and user experience of the user is improved, without affecting rest of others.

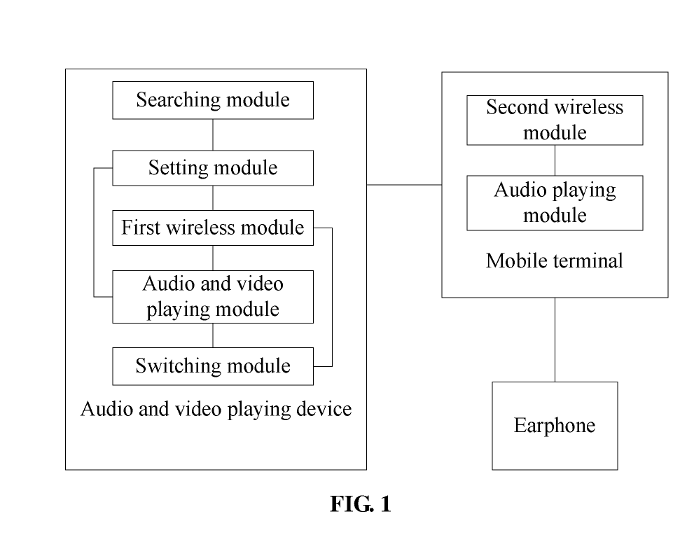

Referring to FIG. 1, a schematic structural diagram illustrating an audio and video playing system according to some embodiments of the present disclosure is given. An audio and video playing system according to a second embodiment of the present disclosure includes: an audio and video playing device, a mobile terminal and an earphone; wherein the audio and video playing device is connected to the mobile terminal in a wireless manner, the earphone is wirelessly or connected to the mobile terminal in a wireless manner, and audio and video signals are played by using the audio and video playing device, the audio signal being transmitted to a corresponding mobile terminal for playing, a user receiving the audio signal via the earphone. In the second embodiment of the present disclosure, the audio and video playing device includes a television, a computer or the like playing device; the mobile terminal includes a mobile phone, a tablet computer or the like terminal devices; the earphone includes a wired earphone, a WiFi earphone, a Bluetooth earphone or the like.

Specifically, the audio and video playing device includes: a searching module, a setting module, a first wireless module, an audio and video playing module and a switching module; wherein the searching module is electrically connected to the first wireless module, the setting module is electrically connected to the audio and video playing module, the first wireless module is electrically connected to the setting module and the audio and video playing module respectively, and the switching module is electrically connected to the first wireless module and the audio and video playing module respectively.

The searching module is configured to search for name information of connectable mobile terminals and select, according to a search result, a mobile terminal to connect.

The setting module is electrically connected to the audio and video playing module, and configured to set a connection manner with the mobile terminal and set the audio and video playing module to a mute state; wherein the connection manner includes WiFi, Bluetooth and the like.

The first wireless module is configured to send a connection request to the mobile terminal to connect searched by the searching module and transmit the audio signal played by the audio and video playing module to the mobile terminal according to the connection manner upon establishing a connection to the corresponding to the mobile terminal.

The audio and video playing module is configured to play the audio and video signals.

The switching module is configured to judge whether the mobile terminal stops playing the audio signal and automatically switch the audio and video playing module from the mute state to a non-mute state if the mobile terminal stops playing the audio signal. According to the present disclosure, when the mobile terminal stops playing the audio signal, the audio and video playing module is automatically switched to a non-mute state by using the switching module, thereby preventing convenience caused by operating the remote control.

The mobile terminal includes a second wireless module and an audio playing module.

The second wireless module is electrically connected to the audio and video playing module, and configured to receive the connection request sent by the first wireless module, receive the audio signal transmitted by the first wireless module upon establishing a connection with the audio and video playing device and enable the audio playing module.

The audio playing module is configured to play the audio signal received by the second wireless module, and transmit the audio signal to the user via the earphone. In the second embodiment of the present disclosure, the audio playing module is a music player, and the user may adjust the volume by using the mobile terminal; if playing over the mobile terminal needs to be canceled, the audio playing module may be directly disabled; when the first wireless module in the video and video playing device detects, via the second wireless module, a termination signal for stopping playing the audio signal, the first wireless module transmits the termination signal to the switching module; upon receipt of the termination signal, the switching module automatically switches the audio and video playing module to the non-mute state, such that normal playing over the audio and video playing device is resumed.

With the audio and video playing system and method according to the second embodiment of the present disclosure, the audio and video playing device is connected to the mobile terminal, when the audio signal fails to be played by using the audio and video playing device, the audio signal is transmitted to the mobile terminal, and the user receives the audio signal by using the earphone connected to the mobile terminal. According to the present disclosure, the operations are simple. During watching of large frames by the audio and video playing device such as a television and the like, sound may be simultaneously received by using the mobile terminal such as a mobile phone and the like. Therefore, watching demands of the user are accommodated and user experience of the user is improved, without affecting rest of others.

The audio and video playing method according to the first embodiment of the present disclosure includes:

connecting an audio and video playing device to a mobile terminal; playing audio and video signals by using the audio and video playing device, and transmitting the audio signal of the audio and video playing device to the mobile terminal; and playing the audio signal transmitted by the audio and video playing device by using the mobile terminal, and transmitting the audio signal to a user via an earphone connected to the mobile terminal in a wireless manner or a wired manner.

The audio and video playing method according to the first embodiment of the present disclosure is simple in operation. When watching large frames by the audio and video playing device such as a television and the like, sound may be simultaneously received by using the mobile terminal such as a mobile phone and the like. Watch demands of the user are accommodated and user experience of the user is improved, without affecting rest of others.

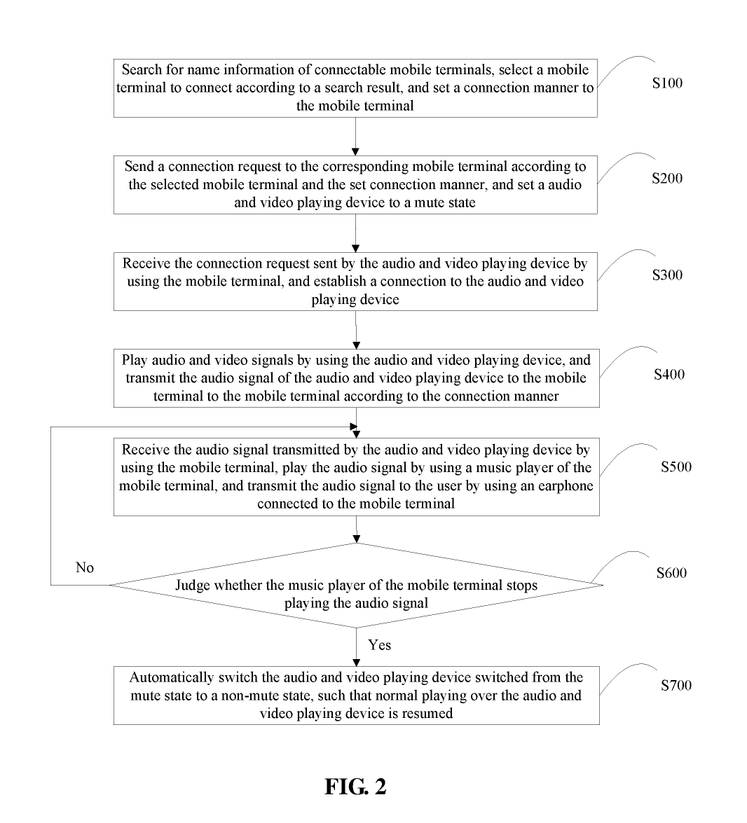

Referring to FIG. 2, a schematic flowchart illustrating an audio and video playing method according to some embodiments of the present disclosure. The audio and video playing method according to the second embodiment of the present disclosure includes:

Step 100: Name information of connectable mobile terminals is searched, a mobile terminal to connect is selected according to a search result, and a connection manner to the mobile terminal is set.

In step 100, the connection manner includes WiFi, Bluetooth or the like.

Step 200: A connection request is sent to the corresponding mobile terminal according to the selected mobile terminal and the set connection manner, and a audio and video playing device is set to a mute state.

Step 300: The connection request sent by the audio and video playing device is received by using the mobile terminal, and a connection to the audio and video playing device is established.

Step 400: Audio and video signals are played by using the audio and video playing device, and the audio signal of the audio and video playing device to the mobile terminal is transmitted to the mobile terminal according to the connection manner.

Step 500: The audio signal transmitted by the audio and video playing device is received by using the mobile terminal, the audio signal is played by using a music player of the mobile terminal, and the audio signal is transmitted to the user by using an earphone connected to the mobile terminal.

In step 500, the earphone includes a wired earphone, a WiFi earphone, a Bluetooth earphone or the like; and the earphone is connected to the mobile terminal via a wire, WiFi or Bluetooth.

Step 600: It is judged whether the music player of the mobile terminal stops playing the audio signal; if the music player of the mobile terminal continues playing the audio signal, step 500 is performed; and if the music player of the mobile terminal stops playing the audio signal, step 700 is performed.

Step 700: The audio and video playing device is automatically switched from the mute state to a non-mute state, such that normal playing over the audio and video playing device is resumed.

In step 700, the user may adjust the volume by using the mobile terminal.

With the audio and video playing method according to the second embodiment of the present disclosure, the audio and video playing device is connected to the mobile terminal, when the audio signal fails to be played by using the audio and video playing device, the audio signal is transmitted to the mobile terminal, and the user receives the audio signal by using the earphone connected to the mobile terminal. According to the present disclosure, the operations are simple. During watching of large frames by the audio and video playing device such as a television and the like, sound may be simultaneously received by using the mobile terminal such as a mobile phone and the like. Therefore, watching demands of the user are accommodated and user experience of the user is improved, without affecting rest of others.

The audio and video playing device and the mobile terminal involved in various embodiments of the present disclosure may be implemented by various general or dedicated computer system environments or configurations. Descriptions hereinafter of the general or dedicated computer system environments or configurations are not intended to limit the audio and video playing device and the mobile terminal involved in various embodiments of the present disclosure, but serve as examples to illustrate the general or dedicated computer system environments or configurations of the audio and video playing device and the mobile terminal involved in various embodiments of the present disclosure. A person skilled in the art to which the present disclosure pertains, upon acquiring information embodied in the following content, would understand how to implement the audio and video playing device and the mobile terminal involved in various embodiments of the present disclosure.

The hardware for implementing various embodiments of the present disclosure includes at least one mobile terminal, at least one audio and video playing device and at least one pair of wired or wireless earphones. A person skilled in the art to which the present disclosure pertains should understand that the mobile terminal includes at least one processor and at least one memory, and the audio and video playing device includes at least one processor and at least one memory. In addition, the hardware for implementing various embodiments of the present disclosure further includes am auxiliary communication network.

Examples of commonly known computer systems, environments and/or configurations applicable to various embodiments of the present disclosure include, but not limited to, a personal computer, a server computer, a hand-held device or lap-top device, a flat-panel device, a multi-processor system, a microprocessor-based system, a set-top box, a programmable consumer electronic device, a network PC, a small-scale computer, a large-scale computer, or a distributed computing environment including any of the above systems or devices.

The computer environments may execute computer executable instructions, for example, program modules. Generally, the program modules include routines, programs, objects, components or data structures for executing specific tasks or implementing specific abstract data types.

The components of the computer may include, but not limited to, a processing unit, a system memory and a bus system which couples various system components including the system memory into the processing unit. The system bus may be any one of several types of bus structures, including a memory bus or a storage controller, a peripheral bus or a local bus using any one of various bus system structures. Illustratively instead of restrictively, such system structures include an industrial standard architecture (ISA) bus, a micro channel architecture (MCA) bus, an enhanced ISA (EISA) bus, a Video Electronics Standards Association (VESA) local bus, and a peripheral component interconnect (PCI) bus (also referred to as a mezzanine bus).

The computer generally includes various computer readable media. The computer readable medium may be any available medium accessible by a computer, and includes volatile and non-volatile media, and removable and irremovable media. Illustratively instead of restrictively, the computer readable media may include computer storage media and communication media. The computer storage medium includes, but not limited to, a random access memory (RAM), a read-only memory (ROM), an electrically erasable programmable read-only memory (EEPROM), a flash memory or another storage technology-based device, a compact disc read-only memory (CD-ROM), digital versatile disk (DVD) or another optical storage and access medium. The communication medium generally embodies computer readable instructions, data structures, program module and other data via modulated data signals over, for example, carriers or other transmission mechanisms, and include any information transmission medium. The term “modulated data signals” refer to signals with one or more features are configured or modified in such a manner that information is coded in the signals. Illustratively instead of restrictively, the communication medium includes such wired medium as a wired network, a wired medium featuring a direct wire connection, and a wireless medium such as an acoustic medium, an RF medium, an infrared medium and other wireless medium. Any combination thereof shall fall within the scope of the computer readable medium.

The system memory includes volatile and/or non-volatile computer storage media, for example, a ROM and a RAM. A basic input/output system (BIOS) including basic routines facilitating information transmission between elements in a computer during startup of the computer is generally stored in the ROM. The RAM generally includes data and/or program modules which may be immediately accessed by a processing unit and/or are currently operated.

The above embodiment describes a preferred implementation manner of the present disclosure. However, the implementation manner of the present disclosure is not limited to the above embodiment. Any variations, modifications, substitutions, combinations, or simplifications, or the like equivalent replacements made to the present disclosure without departing from the spiritual essence and principle of the present disclosure shall all be covered within the protection scope of the present disclosure.

What is claimed is:

1. An audio and video playing system, comprising: an audio and video playing device, a mobile terminal and an earphone; wherein the audio and video playing device is connected to the mobile terminal in a wireless manner, the earphone is connected to the mobile terminal, and audio and video signals are played by using the audio and video playing device, the audio signal being transmitted to a corresponding mobile terminal for playing, a user receiving the audio signal via the earphone.

2. The audio and video playing system according to claim 1, wherein the earphone is connected to the mobile terminal in a wireless manner or a wired manner.

3. The audio and video playing system according to claim 1, wherein the audio and video playing device comprises one or more processors, the one or more processors being configured to execute includes following program modules stored in a memory: a searching module, a setting module, a first wireless module, an audio and video playing module and a switching module; wherein
the searching module is electrically connected to the first wireless module, and configured to search for name information of connectable mobile terminals and select, according to a search result, a mobile terminal to connect;
the setting module is electrically connected to the audio and video playing module, and configured to set a connection manner with the mobile terminal and set the audio and video playing module to a mute state;
the first wireless module is electrically connected to the setting module and the audio and video playing module respectively, and configured to send a connection request to the mobile terminal to connect searched by the searching module and transmit the audio signal played by the audio and video playing module to the mobile terminal according to the connection manner upon establishing a connection to the corresponding to the mobile terminal;
the audio and video playing module is configured to play the audio and video signals; and
the switching module is electrically connected to the first wireless module and the audio and video playing module respectively, and configured to judge whether the mobile terminal stops playing the audio signal and automatically switch the audio and video playing module from the mute state to a non-mute state if the mobile terminal stops playing the audio signal.

4. The audio and video playing system according to claim 3, wherein the mobile terminal includes one or more processors, the one or more processors being configured to execute the following program modules stored in the memory: a second wireless module and an audio playing module; wherein
the second wireless module is electrically connected to the audio and video playing module, and configured to receive the connection request sent by the first wireless module, receive the audio signal transmitted by the first wireless module upon establishing a connection with the audio and video playing device and enable the audio playing module; and
the audio playing module is configured to play the audio signal received by the second wireless module, and transmit the audio signal to the user via the earphone.

5. The audio and video playing system according to claim 1, wherein the audio and video playing device comprises a television or a computer, the mobile terminal comprises a mobile phone or a tablet computer, and the earphone comprises a wired earphone, a WiFi earphone or a Bluetooth earphone.

6. The audio and video playing system according to claim 5, wherein the audio and video playing device is connected to the mobile terminal via WiFi or Bluetooth, and the earphone is connected to the mobile terminal via a wire, WiFi or Bluetooth.

7. The audio and video playing system according to claim 4, wherein the audio playing module is a music player.

8. An audio and video playing method, comprising:
connecting an audio and video playing device to a mobile terminal;
playing audio and video signals by using the audio and video playing device, and transmitting the audio signal of the audio and video playing device to the mobile terminal; and
playing the audio signal transmitted by the audio and video playing device by using the mobile terminal, and transmitting the audio signal to a user via an earphone connected to the mobile terminal.

9. The audio and video playing method according to claim 8, wherein the earphone is connected to the mobile terminal in a wireless manner or a wired manner.

10. The audio and video playing method according to claim 8, wherein the connecting an audio and video playing device to a mobile terminal comprises: searching for name information of connectable mobile terminals and select, according to a search result, a mobile terminal to connect, set a connection manner with the mobile terminal and set the audio and video playing device to a mute state; and the audio and video playing device is wirelessly connected to the mobile terminal.

11. The audio and video playing method according to claim 10, wherein the playing the audio signal transmitted by the audio and video playing device by using the mobile terminal comprises: playing the audio signal transmitted by the audio and video playing device by using an audio player on the mobile terminal; and the earphone comprises a wired earphone, a wireless earphone.

12. The audio and video playing method according to claim 11, wherein upon the playing the audio signal transmitted by the audio and video playing device by using the mobile terminal, and transmitting the audio signal to a user via an earphone connected to the mobile terminal, the method further comprises: judging whether an audio and video playing module on the mobile terminal stops playing the audio signal; if a music player on the mobile terminal continues playing the audio signal, continuing playing the audio signal transmitted by the audio and video playing device by using the mobile terminal; and if the music player on the mobile terminal stops playing the audio signal, automatically switching the audio and video playing device from the mute state to a non-mute state.

13. An audio and video playing system for performing the method according to claim 8, wherein the audio and video playing system comprises: at least one mobile terminal, at least one audio and video playing device and at least one pair of earphones; wherein
the mobile terminal comprises at least one processor and at least one memory, and the audio and video playing device comprises at least one process and at least one memory.
